(19) United States
(12) Patent Application Publication
(10) Pub. No.: US 2026/0042049 A1
(43) Pub. Date: Feb. 12, 2026

(54) STAGGERED BED SYSTEM FOR GAS SEPARATION

(71) Applicant: Saudi Arabian Oil Company, Dhahran (SA)

(72) Inventors: Mourad Younes, Dhahran (SA); Osamah Siddiqui, Dhahran (SA); Abdullah Al Rammah, Dhahran (SA); Jihad Badra, Dhahran (SA)

(21) Appl. No.: 18/795,318

(22) Filed: Aug. 6, 2024

(51) Int. Cl. B01D 53/04

(52) U.S. Cl. CPC B01D 53/0446; B01D 2257/504; B01D 2259/402

(57) ABSTRACT

A system for gas separation includes a first housing, a first reactor section that includes first adsorbent beds that are disposed within the first housing, a second housing, and a second reactor section that includes a second adsorbent bed disposed within the second housing. The first adsorbent beds (i) include respective solid sorbents configured to adsorb target molecules from a fluid stream that is subject to the gas separation and (ii) are arranged in parallel with respect to each other and relative to a flow direction of the fluid stream. The second adsorbent bed (i) includes a respective solid sorbent configured to adsorb the target molecules from the fluid stream and (ii) is staged in series relative to the first adsorbent beds and the flow direction. Each of the first adsorbent beds has a volume that is different from a volume of the second adsorbent bed.

### TECHNICAL FIELD

This description generally relates to systems and methods for fluid separation including gas separation.

### BACKGROUND

Fluid separation, including gas separation, is used for creating intermediate streams or finished products with the desired quality and purity. The fluid separation is used in various applications, such as removing acid gases like sulfur dioxide (SO₂) or carbon dioxide (CO₂) from sour gas in the energy sector or from air, and dehydrating air for industries like pharmaceuticals, manufacturing, and food processing.

### SUMMARY

This disclosure describes technologies relating to staggered bed system for gas separation.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example of a staggered bed system for fluid separation.

FIG. 2 is a diagram of an example of carbon dioxide separation using an example staggered bed system.

FIG. 3 is a diagram of an example of a staggered bed system that incorporates mixing section and depicts adsorption processes.

FIG. 4 is a diagram of an example of a staggered bed system that incorporates mixing section and depicts desorption processes.

FIGS. 5 and 6 are flow chart diagrams of example processes for performing fluid separation based on examples of staggered bed system.

Like reference numbers and designations in the various drawings indicate like elements.

### DETAILED DESCRIPTION

The process of fluid separation can be energy-intensive, depending on the concentration and properties of the molecules that need to be separated. As the demand for reducing CO₂ emissions is growing to cope with climate change, efficient gas separation is becoming even more important. Energy savings and increased productivity are needed to meet these demands.

One example technique for reducing CO₂ emissions is CO₂ separation from air using solid sorbents (e.g., sorbents in adsorbent beds). In this process, for instance, air containing CO₂ is passed through a column filled with solid sorbents, which are materials specifically designed to capture and hold CO₂ molecules. As the air flows through the reactor section, the CO₂ molecules are adsorbed onto the surface of the solid sorbents due to physical or chemical interactions. Once the sorbents are loaded with CO₂, they can be regenerated by increasing the temperature, reducing the pressure, or the like, releasing the captured CO₂ for collection and allowing the sorbents to be reused for another cycle of separation. This method reduces CO₂ levels in the air and can also be applied to various fluid separation processes involving solid or liquid mediums, thereby enhancing the effectiveness of a wide range of fluid separation technologies.

However, the separation using solid sorbents can be energy intensive depending on the concentration of the molecules that need separation. As such, improvement in efficiency or productivity of operations is needed to reduce energy consumption when separating fluids using solid sorbents. More efficient processes can lower energy use while allowing for higher production from existing resources or assets, contributing to efforts to reduce carbon emissions. The productivity herein refers to the rate at which targeted molecules are separated or removed from the feed stream considering a specific amount of sorbent. It measures how much of the targeted molecules are removed over a specific time using a specific amount of sorbent. Thus, increasing the amount of targeted molecules that are separated or removed from the feed stream over a specific time using the same amount of sorbent would increase productivity, leading to more efficient operations.

Implementations in accordance with this disclosure focuses on enhancing such productivity by at least [1] forming two or more layers (e.g., reactor sections) of multiple adsorbent beds, where at least one layer has adsorbent beds that are (i) in parallel configuration with respect to each other and a fluid flow direction and (ii) in series configuration with respect to adsorbent bed(s) in other layer(s), [2] optimizing a volume ratio of adsorbent beds among the multiple adsorbent beds among different layers, and/or [3] optimizing a feed ratio (of a fluid stream that is subject to separation) among different layers of adsorbent beds.

For instance, there can be two layers of multiple adsorbent beds. A first layer can have multiple first adsorbent beds. A second layer can have a second adsorbent bed. The multiple first adsorbent beds can be (i) in parallel configuration with respect to each other and relative to a flow direction of a fluid stream subject to separation and (ii) in series configuration relative to the second adsorbent bed. Further, a volume of each of the multiple first adsorbents beds can be different from a volume of the second adsorbent bed. In some implementations, a ratio between a total volume of the multiple first adsorbent beds and the volume of the second adsorbent bed is 1-3:1. In some implementations, the first layer can be configured to receive an 80-95% percentage (%) of the total volume of the initial fluid stream and the second layer can be configured to receive a 5-20% of the total volume of the initial fluid stream.

Based on [1] such configuration of multiple adsorbent beds among different layers, [2] such variation of a volume ratio (e.g., a ratio between a total volume of the multiple first adsorbent beds and the volume of the second adsorbent bed), and/or [3] such variation of the feed volume ratio among different layers of adsorbent beds, an enhancement in the productivity was observed.

For instance, when compared to a reference case having a fluid separation system that has a single layer of single adsorbent bed but utilizes same volume of adsorbent beds (or same volume of solid adsorbents), above-mentioned two-layer system configuration based on variation of the volume ratio of adsorbent beds or the feed volume ratio exhibited increased productivity. One example experiment that demonstrates such increased productivity is shown in Table 1 of this disclosure.

In some implementations, there can be a mixing layer positioned between the first layer and the second layer. The mixing layer and the first layer can be configured to receive respective portions of a fluid stream. The mixing layer can be configured to (1) receive and mix the respective portion of the fluid stream and an effluent stream from the first layer to form a mixture fluid and (2) output the mixture fluid toward the second layer.

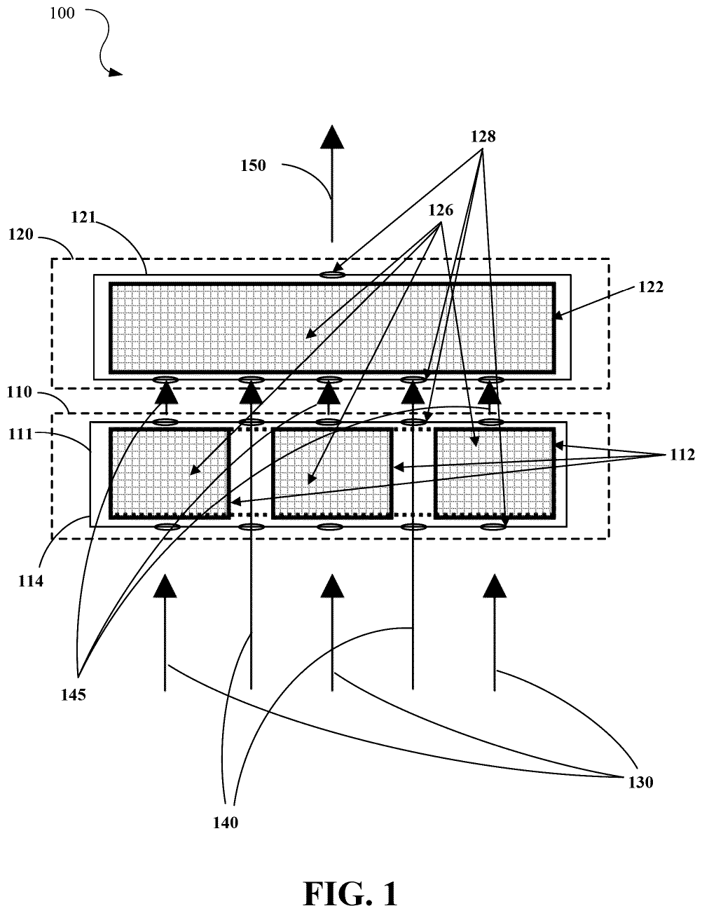

FIG. 1 is a diagram of an example of a staggered bed system 100 for fluid separation. The system 100 can be used for performing fluid separation using adsorbent beds that include solid sorbents configured to adsorb target molecules from a fluid stream that is subject to fluid separation. As described above and throughout this disclosure, the system 100 improves the productivity of the fluid separation at least based on [1] its configuration of multiple adsorbent beds among different reactor sections, [2] variation of a volume ratio of adsorbent beds among different reactor sections, and/or [3] variation of a feed volume ratio. The productivity refers to the rate at which targeted molecules are separated or removed from the fluid stream per unit of sorbent. For instance, the productivity measures the quantity of the targeted molecules that are removed over a specific time using a specific amount of sorbent.

The system 100 includes a first reactor section 110 and a second reactor section 120. The first reactor section 110 includes a first housing 111 and the second reactor section 120 includes a second housing 121. The first housing 111 includes two or more first adsorbent beds 112 and the second housing 121 includes a second adsorbent bed 122. Each of the first adsorbent beds 112 and the second adsorbent bed 112 includes a respective solid sorbent 126 configured to adsorb target molecules from the fluid stream. Moreover, the system 100 can include, be included in, or correspond to, a reactor for performing fluid separation (e.g., gas separation).

The two or more first adsorbent beds 112 are (i) in parallel configuration with respect to each other and relative to a flow direction of the fluid stream and (ii) in series configuration relative to the second adsorbent bed 122. The flow direction is indicated by arrows in FIG. 1 (e.g., arrows corresponding to identifier numerals 130, 140, 145, 150). Moreover, although three first adsorbent beds 112 are shown as an example in FIG. 1, there can be at least two first adsorbent beds 112.

The first housing 111 and the second housing 121 include respective ports 128 (e.g., inlet ports, outlet ports that are illustrated as openings in FIG. 1). Although identifier arrows do not point to all of the opening located on the first housing 111 and the second housing 121, the respective ports 128 are deemed to include all the openings in FIG. 1. In some implementations, one or more of the respective ports 128 can have different sizes to regulate the intake and output volumes of the fluid stream or the flow rates of the intake and output of the fluid stream. In some implementations, one or more valves can be installed on one or more of the respective ports 128 to regulate the intake and output volumes of the fluid stream or the flow rates of the intake and output of the fluid stream.

In some implementations, the first housing 111 and the second housing 121 can collectively be housed in a larger housing. In some implementations, the first reactor section 110 and the first reactor section 110 can correspond to two sections that are dubbed or connected within a reactor for performing fluid separation.

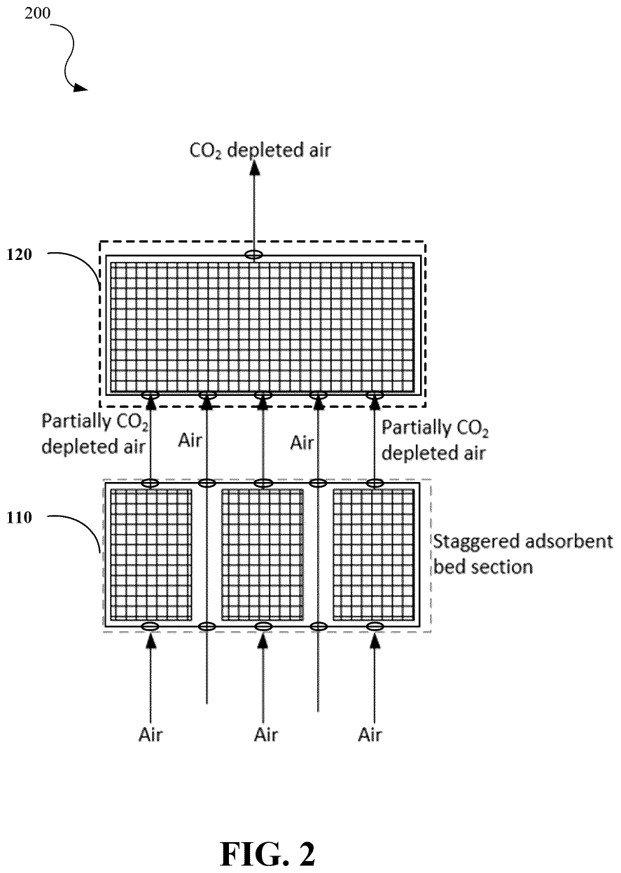

In some implementations, selection of the respective solid sorbent 126 can depend on different types of fluid streams and target molecules to be separated based on the respective solid sorbent 126. For instance, when the fluid stream is air and the target molecules to be separated is CO₂ gas, then the respective solid sorbent can include activated carbon, zeolites, amine-functionalized sorbents, metal organic frameworks, covalent organic frameworks, hydrogen bonded organic frameworks, organic polymers, anion exchange resins, or any other materials that are known by the skilled person. Such CO₂ separation from air is illustrated in FIG. 2 as an example. Further, for instance, when the fluid stream is flue gas and the target molecules to be separated is SO₂ gas, then the respective solid sorbent 126 can include calcium-based compounds such as calcium carbonate, or calcium hydroxide, or amines, or any other materials that are known by the skilled person. Accordingly, there can be different types of respective solid sorbent 126 and selection can be made based on the type of the fluid stream and the target molecules to be separated.

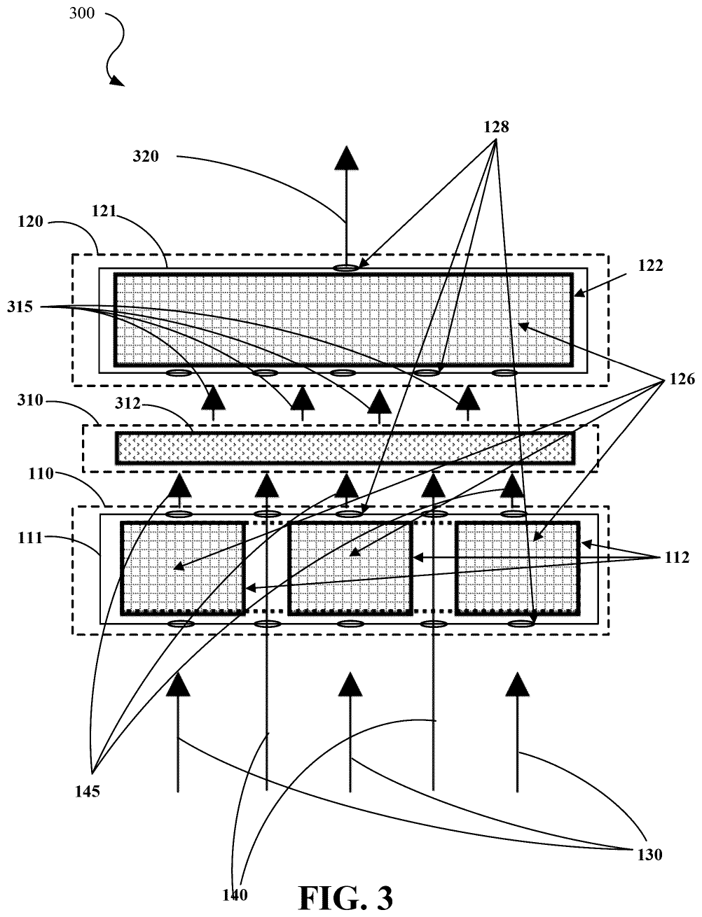

In some implementations, the solid sorbent 126 used in the first adsorbent beds 112 and the second adsorbent bed 122 can be the same or different. For instance, depending on the purpose of the operation or the types of target molecules being separated, the first adsorbent beds 112 and the second adsorbent bed 122 can utilize different types of solid sorbents, respectively. In an example, if the purpose of the operation is to capture CO₂ from air, the water can be co-captured. In such case, one or more of the first adsorbent beds 112 can have different sorbents among the first adsorbent beds 112, which would have different characteristics for selectively capturing CO₂ over water. Further, the sorbent of the second adsorbent bed 122 can be tailored to or selected based on the conditions of the gas exiting the first reactor section 110 (or the mixing section 310 of FIG. 3), which usually would have a lower concentration of CO₂ and water.

In operation, the fluid stream can be fed to the system 100 or the reactor via respective inlet port(s) (of the respective ports 128) of the first housing 114. A first portion 130 of the fluid stream (e.g., initial feed stream) can be brought into contact with respective solid sorbents of the first adsorbent beds 112 of the first reactor section 110 to selectively adsorb, totally or partially, one or more targeted molecules from the first portion 130 of the fluid stream and separate them. Thereafter, an effluent stream 145 from the first reactor section 110 (corresponding to the first portion 130 that went through separation at the first reactor section 110), deprived partially or totally of the targeted molecules, can exit the first reactor section 110 through the respective outlet port(s) (of the respective ports 128) of the first housing 114. The effluent stream 145 can enter the second reactor section 120 via respective inlet port(s) (of the respective ports 128) of the second housing 121, contacting the second adsorbent bed 122 of the second reactor section 120 to selectively adsorb the remainder of the targeted molecules.

Further, in operation, a second portion 140 (or a remainder) of the fluid stream can be fed into the second reactor section 120 without being first fed to the first reactor section 110. For instance, the second portion 140 can pass through respective inlet port(s) (of the respective ports 128) of the first housing 111 and exit through respective outlet port(s) (of the respective ports 128) without being fed to (e.g., without entering) the first adsorbent beds 112, or without contacting the sorbent in the first adsorbent beds 112.

The second portion 140 (or the remainder of the fluid stream) can be brought into contact with the second adsorbent bed 122 of the second reactor section 120 via respective inlet port(s) (of the respective ports 128) of the second housing 121 to selectively adsorb, totally or partially, one or more of the targeted molecules from the second portion 140 of the feed stream and separate them.

An effluent stream 150 from the second reactor section 120 corresponds to a stream that went through separation at the second reactor section 120 and deprived partially or totally of the targeted molecules. The effluent stream 150 can exit the second reactor section 120 via respective outlet port(s) (of the respective ports 128) of the second housing 121 of the second reactor section 120.

Such adsorption process based on the system 100 can last until the first adsorbent beds 112 and the second adsorbent bed 122 are loaded or saturated with the targeted molecules or if the concentration of the targeted molecules in the stream meets a certain threshold. For instance, a process of knowing whether the first adsorbent beds 112 and the second adsorbent bed 122 are loaded or saturated can include monitoring concentration of the target molecules in the effluent streams 145 and 150 over time, measuring pressure drop across the respective adsorbent beds 112 and 122, monitoring temperature changes, utilizing sensor(s) that measure the concentration of target molecules within the adsorbent beds, or the like. Moreover, once the adsorption process is complete, the system 100 or the reactor is subject to a regeneration phase where the targeted molecules are removed from the solid sorbent so that the respective sorbent 126 can start a new cycle. The regeneration phase can involve processes such as thermal desorption, vacuum or pressure swing desorption, passing a purge gas, chemical regeneration, or the like.

In some implementations, a volume ratio between the first portion 130 and the second portion 140 of the fluid stream can be 40-99:1-60. In particular, the ratio can be 80-95:5-20. For instance, the first reactor section 110 can be configured to receive the first portion 130 (being 80-95% of the initial feed stream) via the respective inlet port(s) of the first housing 111 and the second reactor section 120 can be configured to receive the second portion 140 (being 5-20% of the initial feed stream) via the respective inlet port(s) of the second housing 121. In some implementations, the volume ratio between the first portion 130 and the second portion 140 of the fluid stream can be 80:20. In some implementations, one or more ports of the respective ports 128 can have different sizes to regulate the volume ratio. In some implementations, one or more valves can be installed on one or more of the respective ports 128 to regulate the volume ratio.

In some implementations, a volume ratio of adsorbent beds between the second reactor section 120 and the first reactor section 110 can be modulated or varied. For instance, prior to installation of the first adsorbent beds 112 and the second adsorbent bed 122, selection of the first adsorbent beds 112 and the second adsorbent bed 122 can be made based on a pre-determined ratio between the volume of the second adsorbent bed 122 and a total volume of the first adsorbent beds 112. In some implementations, a ratio between the volume of the second adsorbent bed 122 and a total volume of the first adsorbent beds 112 can be 1:0.9-5. In some implementations, the ratio can be 1:1-3. For instance, the ratio between the volume of the second adsorbent bed 122 and the total volume of the first adsorbent beds 112 can be 1:3. In some implementations, when each of the second adsorbent bed 122 and the first adsorbent beds 112 have the same cross-sectional area, the volume ratio can correspond to the thickness (or depth) ratio, and thus, corresponding selection can be made based on the thickness ratio.

In some implementations, there can be a single first adsorbent bed 112 housed in the first housing 111, in which the first housing 11 can have channels that pass through and bypass the sorbent of the single first adsorbent bed 112.

FIG. 2 is a diagram of an example 200 of carbon dioxide separation using the system 100 of FIG. 1. For instance, as bed system depicted in the example 200 corresponds to the system 100 of FIG. 1, the example 200 performs fluid separation using the same techniques disclosed in the system 100.

In operation, air stream corresponds to a fluid stream. A first portion (e.g., the first portion 130) of the air stream can be fed to the first reactor section 110 and a second portion (e.g., the second portion 140) of the air stream can be fed to the second reactor section 120. After CO₂ separation based on the first adsorbent beds at the first reactor section 110, the feed stream deprived partially or totally of the CO₂ can be further fed to the second reactor section 120. In other words, an effluent stream (e.g., the effluent stream 145) from the first reactor section 110 (e.g., first portion of the air stream that went through CO₂ separation at the first reactor section 110) can be fed to the second reactor section 120 along with the second portion of the fluid stream that did not go through separation. At the second reactor section 120, CO₂ separation can be performed and an effluent stream (e.g., the effluent stream 150) from the second reactor section 120, denoted as “CO₂ depleted air” (e.g., the first portion and the second portion of the feed stream that went through separation and deprived partially or totally of the targeted molecules) can exit, as an exit stream.

FIG. 3 is a diagram of an example of a staggered bed system 300 that incorporates mixing section 310 and depicts adsorption processes. The system 300 is an example implementation of the system 100, where the system 300 uses the same configuration and components of the system 100 and further incorporates a mixing section 310. For instance, the system 300 can be viewed in conjunction with the system 100 and/or implementations according to this disclosure.

A fluid stream includes the first portion 130 and the second portion 140 as described above with respect to FIG. 1. For instance, the first portion 130 of the fluid stream can be fed into the first reactor section 110 for fluid separation and the second portion 140 can enter the mixing section 310 without being fed to the first reactor section 110. Once the first reactor section 110 (or the first adsorbent beds 112) performs the fluid separation of the first portion 130, an effluent stream 145 from the first reactor section 110 (e.g., the first portion 130 that went through separation and deprived partially or totally of the targeted molecules from the first reactor section 110) can be sent to the mixing section 310.

The mixing section 310 can include a housing that defines a space designed to increase the mixing effect by, for example, changing the direction of the flow or creating vortices. Further, the mixing section 310 can include inlet and outlet ports. In some implementations, the mixing section 310 can include channels and/or stationary or rotating geometries in the space within the housing.

In some implementations, the mixing section 310 can include static mixers that enable the mixing of the streams. In some implementations, the mixing section can host channels that change the direction of flow or elements that can create turbulence and vortices in the flow. In some implementations, the mixing section can have elements that provide rotating motions, such as swirls, to enhance mixing.

In the mixing section 310, mixing can occur when the fluid path is disturbed, creating turbulence, or when flows collide and mix. This can be achieved through a change in direction, speed, or momentum.

The second portion 140 of the initial feed stream can be sent to and enter the mixing section 310 (e.g., via respective inlet port(s)). The second portion 140 can enter the mixing section 310 without being first fed to the first reactor section 110. For instance, the second portion can 140 can pass through respective inlet port(s) (of the respective ports 128) of the first housing 111 and exit through respective outlet port(s) (of the respective ports 128) without being fed to (or without entering or being in contact with the sorbent in) the first adsorbent beds 112.

In the mixing section 310, the second portion 140 and the effluent stream 145 from the first reactor section 110 can be mixed. Thereafter, a resultant mixed stream 315 can exit the mixing section 310 or mixing zone (e.g., via respective outlet port(s)) and such resultant mixed stream 315 can be sent to the second reactor section 120 for fluid separation. The resultant mixed stream 315 can be brought into contact with the second adsorbent bed 122 of the second reactor section 120 to selectively adsorb, totally or partially, one or more of the targeted molecules of the resultant mixed stream 315. After the separation, a final stream 320 (e.g., final effluent stream) can exit the second reactor section 120 through the respective outlet port(s) of the second housing 121 of the second reactor section 120.

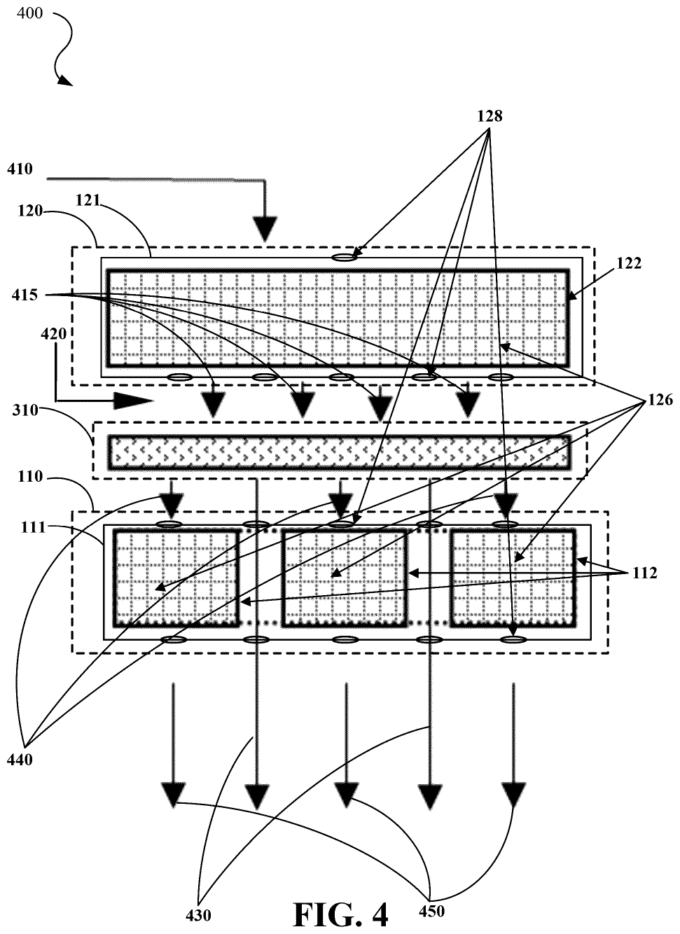

FIG. 4 is a diagram of an example of the staggered bed system 300 that incorporates mixing section and depicts desorption processes. As described above, the system 300 is an example implementation of the system 100, where the system 300 uses the same configuration and components of the system 100 and further incorporates a mixing section 310. For instance, the system 300 can be viewed in conjunction with the system 100 and/or implementations according to this disclosure.

In the desorption phase, a regeneration medium is injected into the second adsorbent bed 122 and the first adsorbent beds 112 at different ports. The regeneration medium can be different for different applications and is known to the person skilled in the art. For instance, the regeneration medium can include a steam, condensable gas, purge gas chemical reagents, or the like. For instance, a typical regeneration medium used in CO₂ capture application can be steam. The regeneration medium can be conveyed through stream 410 and brought in contact with the second adsorbent bed 122 and exit the second reactor section 120 along the desorbed species and goes into the mixing section 310.

Another stream 420 of the regeneration medium can be injected in the mixing section 310, where it gets mixed with a stream 415 (from the second reactor section 120) and exits the mixing section 310. A first portion 430 of the stream (from the mixing section 310) can bypass the first reactor section 110 and exit the system 300 while the remainder portion or a second portion 440 of the stream can be brought into contact with the first adsorbent beds 112 of the first reactor section 110 to desorb the captured molecules and exit the first reactor section 110 as exit stream 450 to the collection port and further treatment.

In some implementations, the stream 410 and 420 of the regeneration medium can be injected in an upward direction from (or below) the first reactor section 110 toward the second reactor section 120.

In some implementations, the stream 410 of the regeneration medium can be operated first before the stream 420 of the regeneration medium, following a specific time sequence that can range between 10 seconds and 10 minutes. In some implementations, it is possible to stop the stream 410 before stopping the stream 420 in a time delay ranging between 10 seconds and 30 minutes. In some implementations, the streams 410 and 420 can be operated simultaneously and stopped at the same time or eventually the stream 410 can be stopped 10 seconds to 30 minutes before the stream 420. Once the sorbent 122 is regenerated, it may not be needed to flow the stream 410 or 420 in that respective section (where the sorbent is regenerated) of the bed. Accordingly, flowing the stream 410, 420 in a time staggered sequence can save stream or save on pressure drop as the stream feed would be localized to the areas that need regeneration.

In some implementations, a flow rate ratio between the stream 410 and the stream 420 can range between 0.1 and 10, more specifically between 0.5 and 5. In some implementations, a flow rate between the stream 410 and the stream 420 can be correlated to the volume ratio of adsorbent beds between the second reactor section 120 and the first reactor section 110. For instance, the flow rate for an adsorbent bed with a smaller volume can be less than that for an adsorbent bed with a larger volume.

Further, similar configuration and techniques can also be applied to the system 100 by incorporating regeneration medium injection points to the (i) second reactor section 120 and (ii) in between the two reactor sections 110 and 120.

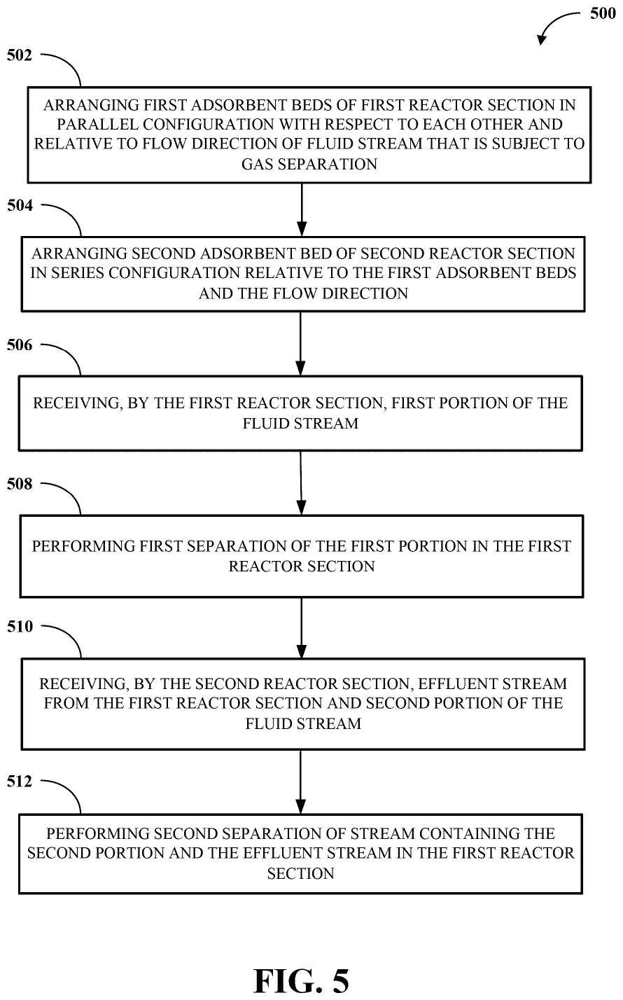

FIG. 5 is a flow chart diagram 500 of an example process for performing fluid separation based on example staggered bed system. For example, the flow chart diagram 500 can implement, be implemented by, or implemented in conjunction with, the systems 100 and 300 and implementations according to this disclosure.

At 502, multiple first adsorbent beds of first reactor section (e.g., the first reactor section 110) can be arranged in parallel configuration with respect to each other and relative to flow direction of fluid stream that is subject to gas separation.

At 504, a second adsorbent bed of second reactor section (e.g., the second reactor section 120) can be arranged in series configuration relative to the first adsorbent beds and the flow direction.

In some implementations, each of the first adsorbent beds has a volume that is different from a volume of the second adsorbent bed. In some implementations, a ratio between a total of volume of the multiple first adsorbent beds and the volume of the second adsorbent bed can be 0.9-5:1. In some implementations, the ratio can be 1-3:1. In some implementations, the ratio can be 3:1. In some implementations, when each of the first solid sorbent and the first adsorbent beds have the same cross-sectional area, the ratio can correspond to the thickness (or depth) ratio.

At 506, a first portion (e.g., the first portion 130) of a total volume of the fluid stream is received by the first reactor section via respective inlet port(s) of a first housing (e.g., the first housing 111) of the first reactor section.

At 508, a first separation of the first portion is performed in the first reactor section based on the first portion flowing through the multiple first adsorbent beds. For instance, the first portion can be brought into contact with the second adsorbent beds of the second reactor section to selectively adsorb, totally or partially, one or more targeted molecules of the first portion of the feed stream and separate them. Thereafter, an effluent stream (e.g., the effluent stream 145) from the first portion that went through the first separation and deprived partially or totally of the targeted molecules can exit the first reactor section through respective outlet port(s) of the first housing of the first reactor section. Such effluent stream can then enter the second reactor section via respective inlet port(s) of a second housing (e.g., the second housing 121) of the second reactor section.

At 510, the effluent stream from the first reactor section and second portion (e.g., the second portion 140) of the total volume of the fluid stream is received by the second reactor section via respective inlet port(s) of the second housing of the second reactor section. Here, the second portion does not enter first adsorbent beds before being received by the second reactor section. For instance, the second portion can pass through respective inlet port(s) of the first housing and exit through respective outlet port(s) without being fed to the first solid sorbent beds or without being contacted with the sorbent in the first beds.

In some implementations, one or more of the respective inlet or outlet ports of the first housing or the second housing can have different sizes to regulate the intake and output volumes of the fluid stream or the flow rates of the intake and output of the fluid stream. In some implementations, one or more valves can be installed on one or more of the respective inlet or outlet ports to regulate the intake and output volumes of the fluid stream or the flow rates of the intake and output of the fluid stream.

In some implementations, a volume ratio between the first portion and the second portion of the fluid stream (e.g., initial feed stream) can be 40-99:1-60. In particular, the volume ratio can be 80-95:5-20. For instance, the first reactor section can be configured to receive the second portion receive the first portion (being 80-95%) of a total volume of the fluid stream (via respective inlets of the first housing) and the second reactor section can be configured to receive the second portion (being 5-20%) of the total volume of the fluid stream (via respective inlets of the second housing). In some implementations, the volume ratio between the first portion and the second portion can be 80:20. In some implementations, the flow rate ratio between the first portion and the second portion can be 80:20.

At 512, a second separation is performed in the second reactor section. For instance, the second separation can be performed on a stream containing the second portion and/or the effluent stream (that came from the first reactor section). For instance, the stream can be brought into contact with the second adsorbent bed of the second reactor section to selectively adsorb, totally or partially, one or more targeted molecules from the stream and separate them. Thereafter, an effluent (e.g., the effluent 150) from the first reactor section that went through the second separation and deprived partially or totally from the targeted molecules) can exit the second reactor section.

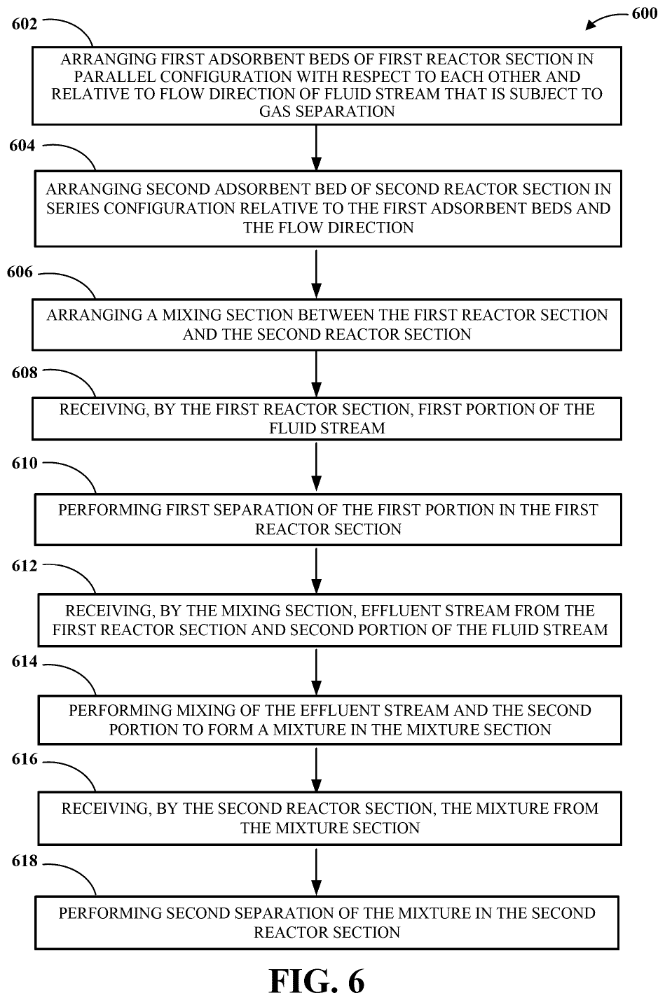

FIG. 6 is a flow chart diagram 600 of an example process for performing fluid separation based on example staggered bed system. For example, the flow chart diagram 600 can implement, be implemented by, or implemented in conjunction with, the systems 100 and 300 and implementations (including the flow chart diagram 500 of FIG. 5) according to this disclosure.

At 602, multiple first adsorbent beds of first reactor section (e.g., the first reactor section 110) can be arranged in parallel configuration with respect to each other and relative to flow direction of fluid stream that is subject to gas separation. As the step 602 can be the same as the step 502 of FIG. 5, the technique or implementations will not be repeated here.

At 604, a second adsorbent bed of second reactor section (e.g., the second reactor section 120) can be arranged in series configuration relative to the first adsorbent beds and the flow direction. As the step 604 can be the same as the step 504 of FIG. 5, the technique or implementations will not be repeated here.

At 606, a mixing section (e.g., the mixing section 310) between the first reactor section and the second reactor section is arranged.

At 608, a first portion (e.g., the first portion 130) of a total volume of a fluid stream is received by the first reactor section. As the step 608 can be the same as the step 506 of FIG. 5, the technique or implementations will not be repeated here.

At 610, a first separation of the first portion is performed in the first reactor section based on the first portion flowing through the multiple first adsorbent beds. As the step 610 can be the same as the step 508 of FIG. 5, the technique or implementations will not be repeated here.

At 612, an effluent stream (e.g., the effluent stream 145) from the first reactor section and a second portion (e.g., the second portion 140) of the total volume of the fluid stream is received by the mixture section. The second portion does not enter the first adsorbent beds before being received by the mixing section.

In some implementations, one or more of respective inlet or outlet ports of the first housing, the second housing, or the mixing section can have different sizes to regulate the intake and output volumes of the fluid stream or the flow rates of the intake and output of the fluid stream. In some implementations, one or more valves can be installed on one or more of the respective inlet or outlet ports to regulate the intake and output volumes of the fluid stream or the flow rates of the intake and output of the fluid stream.

In some implementations, a volume ratio between the first portion and the second portion of the fluid stream (e.g., initial feed stream) can be 40-99:1-60. In particular, the volume ratio can be 80-95:5-20. For instance, the first reactor section can be configured to receive the second portion receive the first portion (being 80-95%) of a total volume of the fluid stream (via respective inlet port(s) of the first housing) and the second reactor section can be configured to receive the second portion (being 5-20%) of the total volume of the fluid stream (via respective inlet port(s) of the mixing section). In some implementations, the volume ratio between the first portion and the second portion can be 80:20. In some implementations, the flow rate ratio between the first portion and the second portion can be 80:20.

At 614, a mixing of the first effluent stream and the second portion is performed to form a mixture (e.g., the resultant mixed stream 315). For instance, at the mixing section, the second portion and the effluent stream flowing from the second reactor section can be mixed based on a stream containing the effluent stream and the second portion flowing through the mixture section. Thereafter, the resultant mixed stream can exit the mixing section (e.g., via respective outlet port(s) of the mixing section) and such resultant mixed stream can be sent to the second reactor section.

At 616, the resultant mixed stream is received by the second reactor section via respective inlet port(s) of the second housing of the second reactor section.

At 618, a second separation of the resultant mixed stream can be performed at the second reactor section. For instance, the mixed stream can be brought into contact with the second solid sorbent of the second reactor section, based on the mixed stream flowing through the second adsorbent bed, to selectively adsorb, totally or partially, one or more of the targeted molecules from the mixed stream. After the separation, a final stream (e.g., the final stream 320) can exit the second reactor section.

### EXAMPLES

In such instances described above with respect to the system 100, improvement in the productivity of the targeted molecule separation was observed, compared to a system or a case (referred herein as “reference case”) where there is a single reactor section having a single solid adsorbent bed. As a prerequisite before conducting an example experiment, the system 100 and the reference case utilized the same total volume of adsorbent beds (e.g., total volume of the adsorbent bed or solid sorbent in the reference case=total volume of all of the adsorbent beds or solid sorbents in the system 100).

The example experiment was conducted to compare the system 100 and the reference case by [1] varying a volume ratio of adsorbent beds among the multiple adsorbent beds in the system 100, and [2] varying a feed volume ratio (e.g., the first portion 130 and the second portion 140) in the system 100 to find the optimized volume ratio and the feed volume ratio for optimizing the productivity of the fluid separation based on the system 100. In the reference case, as there is only one solid adsorbent bed in its system, there was no division of feed stream into different portions. Moreover, as each of adsorbent beds used in the system 100 of this example experiment had the same cross-sectional area, only bed depth (e.g., bed thickness) was varied to correspondingly vary the volume among the multiple adsorbent beds between the second reactor section 120 and the first reactor section 110, to thereby evaluate changes in the productivity.

Below Table 1 summarizes the results of the example experiment. Table 1 shows the CO₂ recovered for different bed depth ratios (corresponding to the volume ratios) observed with varying feed ratios for each bed or each reactor section. In comparison to the reference case with packed adsorbent bed having 20 cm bed depth that entails a CO₂ productivity of 169 kg CO₂/kg Sorbent/day, it was found that a staggered bed design (e.g., the system 100) having a volume ratio (ratio between the total volume of the first adsorbent beds 112 and the volume of the second adsorbent bed 122) being 3:1 (e.g., 15 cm bed depth:5 cm bed depth) can provide a higher productivity of 184 kg CO₂/kg Sorbent/day, when the first reactor section 110 is fed with 80% (corresponding to the first portion 130) of the feed gas. For reference, in the Table 1, “5 cm+15 cm bed depth” refers to (i) 5 cm bed depth of the second adsorbent bed 122 and (ii) 15 cm total bed depths that account for all of the first adsorbent beds 112. In other words, the volume ratio between the second adsorbent bed 122 and total of the first adsorbent beds 112 is 1:3. Moreover, “feed ratio” refers to the first portion 130, or a proportion of the initial feed stream that is fed into the first reactor section 110. Moreover, “feed ratio 0.8” corresponds a scenario where 80% of a total volume of the initial feed stream is fed into the first reactor section 110 and the remainder 20% of the total volume is fed into the second reactor section 120.

TABLE 1
CO₂ recovered for various bed geometries and feed ratios
(Productivity in kg CO₂ per kg sorbent per specific time)

| Reference Case | | 20 cm bed depth | 30 cm bed | 40 cm bed |
|---|---|---|---|---|
| | | | depth | depth |
| | | 169 kg CO₂/kg Sorbent/ | 139 | 116 |
| | | day | | |
| Current | | 5 cm | 10 cm + 20 cm | 10 cm + 30 cm |
| Disclosure | | (2^{nd} adsorbent bed 122) + | bed depth | bed depth |
| | | 15 cm | | |
| | | (1^{st} adsorbent beds 112) | | |
| | | bed depth | | |
| | feed ratio | 184 kg CO₂/kg Sorbent/ | 146 | 122 |
| | 0.8 | day | | |
| | | 10 cm | 15 cm + 15 cm | 20 cm + 20 cm |
| | | (2^{nd} adsorbent bed 122) + | bed depth | bed depth |
| | | 10 cm | | |
| | | (1^{st} adsorbent beds 112) | | |
| | | bed depth | | |
| | feed ratio | 169 kg CO₂/kg Sorbent/ | 139 | 114 |
| | 0.5 | day | | |
| | feed ratio | 176 kg CO₂/kg Sorbent/ | 145 | 121 |
| | 0.8 | day | | |
| | feed ratio | 177 kg CO₂/kg Sorbent/ | 145 | 121 |
| | 0.9 | day | | |

Accordingly, it was observed that, based on [1] such configuration of multiple adsorbent beds among different reactor sections, [2] optimization of the volume ratio (e.g., a ratio between a total volume of the multiple first adsorbent beds and the volume of the second adsorbent bed), and/or [3] optimization of the feed ratio among different reactor sections of adsorbent beds, the productivity was enhanced.

### Embodiments

According to one aspect of the subject matter described in this application, a system for gas separation can include a first housing, a first reactor section that includes first adsorbent beds that are disposed within the first housing, a second housing, and a second reactor section that includes a second adsorbent bed disposed within the second housing. The first adsorbent beds can (i) include respective solid sorbents configured to adsorb target molecules from a fluid stream that is subject to the gas separation and (ii) be arranged in parallel with respect to each other and relative to a flow direction of the fluid stream. The second adsorbent bed can (i) include a respective solid sorbent configured to adsorb the target molecules from the fluid stream and (ii) be staged in series relative to the first adsorbent beds and the flow direction. Each of the first adsorbent beds can have a volume that is different from a volume of the second adsorbent bed.

Implementations according to this aspect can include one or more of the following features. For example, a ratio between a total volume of the first adsorbent beds and the volume of the second adsorbent bed can be 0.9-5:1.

In some implementations, a ratio between a total volume of the first adsorbent beds and the volume of the second adsorbent bed can be 1-3:1.

In some implementations, the first reactor section and the second reactor section can be configured to receive a respective portion of a total volume of the fluid stream via one or more respective ports of the first housing and the second housing. The first housing can include respective one or more inlet ports configured to receive an 80-95% of the total volume of the fluid stream and the second housing can include respective one or more inlet ports configured to receive a 5-20% of the total volume of the fluid stream.

In some implementations, the first reactor section can be configured to receive an 80% of the total volume of the fluid stream and the second reactor section can be configured to receive a 20% of the total volume of the fluid stream. In such implementations, a ratio between a total volume of the first adsorbent beds and the volume of the second adsorbent bed can be 1-3:1.

In some implementations, the system for gas separation can further include a mixing section, where the mixing section is positioned between the first reactor section and the second reactor section. The mixing section and the first reactor section can be configured to receive a respective portion of a total volume of the fluid stream via respective inlet ports of the first housing and the mixing section. The mixing section can be configured to (i) receive and mix the respective portion of the fluid stream and an effluent stream from the second reactor section to form a mixture fluid and (2) output the mixture fluid toward the second reactor section via one or more respective ports of the mixing section. The second reactor section can be configured to (i) receive the mixture fluid via one or more respective inlet ports of the second housing and (ii) selectively separate the target molecules. In such implementations, a ratio between a total volume of the first adsorbent beds and the volume of the second adsorbent bed can be 1-3:1. Further, in such implementations, the mixing section can include respective one or more inlet ports configured to receive a 5-20% of the total volume of the fluid stream and the first housing can include respective one or more inlet ports configured to receive an 80-95% of the total volume of the fluid stream.

In some implementations, the first housing and the second housing can be disposed within a third housing.

According to another aspect of the subject matter described in this application, a method can include: arranging first adsorbent beds of a first reactor section in a parallel configuration with respect to each other and relative to a flow direction of a fluid stream that is subject to a gas separation; arranging a second adsorbent bed of a second reactor section in a series configuration relative to the first adsorbent beds and the flow direction, where each of the first adsorbent beds has a volume that is different from a volume of the second adsorbent bed; receiving, by the first reactor section, a first portion of a total volume of the fluid stream; performing, based on the first portion flowing through the first adsorbent beds, a first separation of the first portion in the first reactor section; receiving, by the second reactor section, an effluent stream from the first reactor section and a second portion of the total volume of the fluid stream, where the second portion does not enter the first adsorbent beds before being received by the second reactor section; and performing, based on a stream containing the effluent stream and the second portion flowing through the second adsorbent bed, a second separation of the stream in the second reactor section.

Implementations according to this aspect can include one or more of the following features. For example, a ratio between a total volume of the first adsorbent beds and the volume of the second adsorbent bed can be 0.9-5:1.

In some implementations, a ratio between a total volume of the first adsorbent beds and the volume of the second adsorbent bed can be 1-3:1.

In some implementations, the first reactor section can be configured to receive an 80-95% of a total volume of the fluid stream and the second reactor section can be configured to receive a 5-20% of the total volume of the fluid stream.

In some implementations, the first reactor section can be configured to receive an 80% of the total volume of the fluid stream and the second reactor section is configured to receive a 20% of the total volume of the fluid stream.

In some implementations, a ratio between a total volume of the first adsorbent beds and the volume of the second adsorbent bed is 1-3:1.

According to another aspect of the subject matter described in this application, a method can include: arranging first adsorbent beds of a first reactor section in a parallel configuration with respect to each other and relative to a flow direction of a fluid stream that is subject to a gas separation; arranging a second adsorbent bed of a second reactor section in a series configuration relative to the first adsorbent beds and the flow direction, where each of the first adsorbent beds has a volume that is different from a volume of the second adsorbent bed; arranging a mixing section between the first reactor section and the second reactor section; receiving, by the first reactor section, a first portion of a total volume of the fluid stream; performing, based on the first portion flowing through the first adsorbent beds, a first separation of the first portion in the first reactor section; receiving, by the mixing section, an effluent stream from the first reactor section and a second portion of the total volume of the fluid stream, where the second portion does not enter the first adsorbent beds before being received by the mixing section; performing, in the mixing section and based on a stream containing the effluent stream and the second portion flowing through the mixing section, a mixing of the effluent stream and the second portion to form a mixture; receiving, by the second reactor section, the mixture from the mixing section; and performing, in the second reactor section and based on the mixture flowing through the second adsorbent bed, a second separation of the mixture.

Implementations according to this aspect can include one or more of the following features. For example, a ratio between a total volume of the first adsorbent beds and the volume of the second adsorbent bed can be 0.9-5:1.

In some implementations, a ratio between a total volume of the first adsorbent beds and the volume of the second adsorbent bed can be 1-3:1.

In some implementations, the mixing section can be configured to receive a 5-20% of the total volume of the fluid stream and the first reactor section can be configured to receive an 80-95% of the total volume of the fluid stream.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. A system for gas separation, the system comprising:
a first housing;
a first reactor section comprising a plurality of first adsorbent beds that are disposed within the first housing, wherein the plurality of first adsorbent beds (i) comprise respective solid sorbents configured to adsorb target molecules from a fluid stream that is subject to the gas separation and (ii) are arranged in parallel with respect to each other and relative to a flow direction of the fluid stream;
a second housing; and
a second reactor section comprising a second adsorbent bed disposed within the second housing, wherein the second adsorbent bed (i) comprises a respective solid sorbent configured to adsorb the target molecules from the fluid stream and (ii) is staged in series relative to the plurality of first adsorbent beds and the flow direction, and wherein each of the plurality of first adsorbent beds has a volume that is different from a volume of the second adsorbent bed.

2. The system of claim 1, wherein a ratio between a total volume of the plurality of first adsorbent beds and the volume of the second adsorbent bed is 0.9-5:1.

3. The system of claim 1, wherein a ratio between a total volume of the plurality of first adsorbent beds and the volume of the second adsorbent bed is 1-3:1.

4. The system of claim 1, wherein the first reactor section and the second reactor section are configured to receive a respective portion of a total volume of the fluid stream via one or more respective ports of the first housing and the second housing, and
wherein, the first housing comprises respective one or more inlet ports configured to receive an 80-95% of the total volume of the fluid stream and the second housing comprises respective one or more inlet ports configured to receive a 5-20% of the total volume of the fluid stream.

5. The system of claim 4, wherein the first reactor section is configured to receive an 80% of the total volume of the fluid stream and the second reactor section is configured to receive a 20% of the total volume of the fluid stream.

6. The system of claim 4, wherein a ratio between a total volume of the plurality of first adsorbent beds and the volume of the second adsorbent bed is 1-3:1.

7. The system of claim 1, further comprising:
a mixing section, wherein the mixing section is positioned between the first reactor section and the second reactor section,
wherein the mixing section and the first reactor section are configured to receive a respective portion of a total volume of the fluid stream via respective inlet ports of the first housing and the mixing section,
wherein the mixing section is configured to (i) receive and mix the respective portion of the fluid stream and an effluent stream from the second reactor section to form a mixture fluid and (2) output the mixture fluid toward the second reactor section via one or more respective ports of the mixing section, and
wherein the second reactor section is configured to (i) receive the mixture fluid via one or more respective inlet ports of the second housing and (ii) selectively separate the target molecules.

8. The system of claim 7, wherein a ratio between a total volume of the plurality of first adsorbent beds and the volume of the second adsorbent bed is 1-3:1.

9. The system of claim 8, wherein the mixing section comprises respective one or more inlet ports configured to receive a 5-20% of the total volume of the fluid stream and the first housing comprises respective one or more inlet ports configured to receive an 80-95% of the total volume of the fluid stream.

10. The system of claim 1, wherein the first housing and the second housing are disposed within a third housing.

11. A method comprising:
arranging a plurality of first adsorbent beds of a first reactor section in a parallel configuration with respect to each other and relative to a flow direction of a fluid stream that is subject to a gas separation,
arranging a second adsorbent bed of a second reactor section in a series configuration relative to the plurality of first adsorbent beds and the flow direction, wherein each of the plurality of first adsorbent beds has a volume that is different from a volume of the second adsorbent bed;
receiving, by the first reactor section, a first portion of a total volume of the fluid stream;
performing, based on the first portion flowing through the plurality of first adsorbent beds, a first separation of the first portion in the first reactor section;
receiving, by the second reactor section, an effluent stream from the first reactor section and a second portion of the total volume of the fluid stream, wherein the second portion does not enter the plurality of first adsorbent beds before being received by the second reactor section; and
performing, based on a stream containing the effluent stream and the second portion flowing through the second adsorbent bed, a second separation of the stream in the second reactor section.

12. The method of claim 11, wherein a ratio between a total volume of the plurality of first adsorbent beds and the volume of the second adsorbent bed is 0.9-5:1.

13. The method of claim 11, wherein a ratio between a total volume of the plurality of first adsorbent beds and the volume of the second adsorbent bed is 1-3:1.

14. The method of claim 11, wherein the first reactor section is configured to receive an 80-95% of a total volume of the fluid stream and the second reactor section is configured to receive a 5-20% of the total volume of the fluid stream.

15. The method of claim 11, wherein the first reactor section is configured to receive an 80% of the total volume of the fluid stream and the second reactor section is configured to receive a 20% of the total volume of the fluid stream.

16. The method of claim 15, wherein a ratio between a total volume of the plurality of first adsorbent beds and the volume of the second adsorbent bed is 1-3:1.

17. A method comprising:
arranging a plurality of first adsorbent beds of a first reactor section in a parallel configuration with respect to each other and relative to a flow direction of a fluid stream that is subject to a gas separation,
arranging a second adsorbent bed of a second reactor section in a series configuration relative to the plurality of first adsorbent beds and the flow direction, wherein each of the plurality of first adsorbent beds has a volume that is different from a volume of the second adsorbent bed;
arranging a mixing section between the first reactor section and the second reactor section;
receiving, by the first reactor section, a first portion of a total volume of the fluid stream;
performing, based on the first portion flowing through the plurality of first adsorbent beds, a first separation of the first portion in the first reactor section;
receiving, by the mixing section, an effluent stream from the first reactor section and a second portion of the total volume of the fluid stream, wherein the second portion does not enter the plurality of first adsorbent beds before being received by the mixing section;
performing, in the mixing section and based on a stream containing the effluent stream and the second portion flowing through the mixing section, a mixing of the effluent stream and the second portion to form a mixture;
receiving, by the second reactor section, the mixture from the mixing section; and
performing, in the second reactor section and based on the mixture flowing through the second adsorbent bed, a second separation of the mixture.

18. The method of claim 17, wherein a ratio between a total volume of the plurality of first adsorbent beds and the volume of the second adsorbent bed is 0.9-5:1.

19. The method of claim 17, wherein a ratio between a total volume of the plurality of first adsorbent beds and the volume of the second adsorbent bed is 1-3:1.

20. The method of claim 17, wherein the mixing section is configured to receive a 5-20% of the total volume of the fluid stream and the first reactor section is configured to receive an 80-95% of the total volume of the fluid stream.
